(19) United States
(12) Patent Application Publication
(10) Pub. No.: US 2026/0220498 A1
(43) Pub. Date: Jul. 30, 2026

(54) GEN-AI BASED SYSTEM AND METHOD FOR OPTIMIZING PREDICTIVE AI MODELS THROUGH MULTIDIMENSIONAL ASSESSMENT

(71) Applicant: Exafluence Inc USA, South Brunswick, NJ (US)

(72) Inventors: Karthikeyan Sankaran, Chennai (IN); Kalaivani K. G, Chennai (IN); S. Gopalkrishnan, Chennai (IN)

(21) Appl. No.: 19/396,527

(22) Filed: Nov. 21, 2025

Related U.S. Application Data
(60) Provisional application No. 63/749,738, filed on Jan. 27, 2025.

(51) Int. Cl. G06N 5/025

(52) U.S. Cl. CPC G06N 5/025

(57) ABSTRACT

A Gen-AI-based system and method for optimizing a predictive AI model through multidimensional assessment is disclosed. The Gen-AI-based system receives the predictive AI model in one or more formats and associated contextual model data, generates a text-based model representation using parsing, extraction, and relationship-evaluation procedures, and evaluates the model using analytical and dimension-specific rule-matching procedures across a plurality of assessment dimensions to produce a structured assessment output. The Gen-AI subsystem autonomously generates assessment queries or receives user-provided queries to determine model attributes. The Gen-AI-based system aggregates model information and embeds prompt orchestration directives to produce rule-based prompts processed by an AI-based reasoning subsystem to generate analytical responses. A model optimization subsystem synthesizes these analytical responses with the structured assessment output to generate optimization recommendations. The disclosed system enables automated, explainable, and context-aware optimization of predictive AI models using generative AI-driven reasoning.

### CROSS REFERENCE TO RELATED APPLICATION(S

This application claims the priority to and incorporates by reference the entire disclosure of U.S. provisional patent application bearing No. 63/749,738 filed on January 27, 2025.

### TECHNICAL FIELD

Embodiments of the present disclosure relate to artificial intelligence-based model validation systems and, more particularly, to a generative artificial intelligence (Gen-AI)-based system and method for optimizing a predictive artificial intelligence (AI) model through multidimensional assessment.

### BACKGROUND

Predictive artificial intelligence (AI) models are widely used across various industries to support decision-making, automate analytical processes, and generate outcome predictions based on historical or real-time data. As these predictive AI models grow in complexity, organizations increasingly rely on a variety of modeling frameworks, markup representations, and machine-learning pipelines, resulting in predictive AI models that differ significantly in structure, interpretability, and operational behavior. Existing systems often require substantial manual effort to analyze, interpret, and evaluate such predictive AI models, particularly when the predictive AI models are represented in formats such as predictive model markup language (PMML), extensible markup language (XML)-based structures, or serialized machine-learning artifacts.

Traditional predictive AI model evaluation approaches typically focus on limited performance indicators and fail to provide a holistic, multidimensional assessment of the predictive AI model. These approaches may overlook aspects such as feature dependencies, transformation consistency, model-logic correctness, sensitive-attribute usage, governance considerations, and deployment-specific risks. Manual assessments further introduce inconsistencies, delays, and the possibility of human error, especially when evaluating high-dimensional or heavily engineered models.

Furthermore, existing predictive AI model evaluation approaches do not effectively support the automated extraction, interpretation, and transformation of predictive AI model artifacts into a form that can be consistently analyzed across heterogeneous modeling environments. Many predictive AI model evaluation systems lack the ability to generate context-aware analytical queries or to perform reasoning across multiple dimensions of model behavior, resulting in incomplete insights and limited diagnostic accuracy. Additionally, conventional platforms do not provide mechanisms for synthesizing analytical findings into actionable recommendations that guides optimization or remediation of the predictive AI model.

With the increasing availability of Gen-AI tools, there is growing interest in leveraging generative reasoning capabilities for AI model analysis. However, current solutions do not integrate generative reasoning with systematic prompt construction, structured analysis workflows, or rule-based evaluation frameworks. Without such integration, Gen-AI output often lacks structure, interpretability, or alignment with model governance requirements.

Therefore, there is a need for improved computerized techniques that able to perform comprehensive interpretation, multidimensional assessment, and automated reasoning on the predictive AI models represented in diverse formats. There is a further need for methods and systems capable of generating context-aware analytical queries, orchestrating structured prompts, leveraging advanced reasoning capabilities, and deriving optimization insights in a consistent and repeatable manner. Additionally, improved Gen-AI systems are required to derive actionable recommendations that assist practitioners in enhancing the reliability, robustness, and operational performance of the predictive AI models.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a Gen-AI-based method for optimizing a predictive AI model through multidimensional assessment is disclosed. In the first step, the Gen-AI-based method includes receiving, by one or more hardware processors through an ingestion subsystem, the predictive AI model in one or more formats from one or more model sources, and contextual model data associated with the predictive AI model via a user interface from a user associated with a user profile. The predictive AI model in the one or more formats comprises one of: a PMML file format, an XML file format containing a PMML content, and a serialized machine-learning model file format. The contextual model data comprises at least one of: model metadata, model version information, feature descriptions, training dataset characteristics, commercial context parameters, performance metrics, model governance attributes, deployment environment information, usage constraints, and intended application details.

In the next step, the Gen-AI-based method includes converting, by the one or more hardware processors through a model conversion subsystem, the one of: the XML file format containing the PMML content, and the serialized machine-learning model file format, into the PMML file format. In the next step, the Gen-AI-based method includes performing, by the one or more hardware processors through a model interpretation subsystem, at least one of: parsing procedures, extraction procedures, and relationship-evaluation procedures to generate a text-based model representation of the predictive AI model. The parsing procedures comprise processing the PMML file format associated with the predictive AI model together with the contextual model data to identify parsed model elements comprising at least one of: a model type, input fields, transformation logic, decision logic, and output specifications. The extraction procedures comprise retrieving predictive AI model components comprising at least one of: feature definitions, statistical parameters, threshold conditions, preprocessing steps, and scoring rules from the parsed model elements. The relationship-evaluation procedures comprise analyzing relationships among the parsed model elements and the extracted predictive AI model components to identify at least one of: feature-to-prediction dependencies, transformation chains, and scoring flows.

In the next step, the Gen-AI-based method includes performing, by the one or more hardware processors through a multidimensional assessment subsystem, at least one of: analytical procedures and dimension-specific rule-matching procedures using a plurality of assessment dimensions, for generating a structured assessment output to evaluate the predictive AI model using the text-based model representation. The analytical procedures comprise at least one of: identifying feature coverage, transformation consistency, model logic structure, sensitive-attribute usage, complexity indicators, and output behavior. The plurality of assessment dimensions comprise at least one of: operational alignments, a data quality, model engineering, model governance, decision-system integrity, an environmental impact, and a social impact. The structured assessment output comprises at least one of: identified strengths, deficiencies, model risks, and performance characteristics of the predictive AI model mapped to the plurality of assessment dimensions.

In the next step, the Gen-AI-based method includes autonomously generating, by the one or more hardware processors through a Gen-AI subsystem, one or more assessment queries based on analysis of the text-based model representation of the predictive AI model and the structured assessment output. In the next step, the Gen-AI-based method includes receiving, by the one or more hardware processors through the Gen-AI subsystem, the one or more assessment queries via the user interface from the user to determine model attributes of the predictive AI model. The model attributes comprise at least one of: detailed characteristics of the predictive AI model, dependencies of the predictive AI model, the decision logic, the model risks, and model behaviors.

In the next step, the Gen-AI-based method includes aggregating, by the one or more hardware processors through a prompt management subsystem, the text-based model representation, the contextual model data, and the one or more assessment queries into an aggregated prompt context. In the next step, the Gen-AI-based method includes embedding, by the one or more hardware processors through the prompt management subsystem, one or more prompt orchestration directives into the aggregated prompt context to generate one or more rule-based prompts. The one or more prompt orchestration directives comprise at least one of: Gen-AI-based system instructions, output-format constraints, analysis directives, and response guardrails.

In the next step, the Gen-AI-based method includes processing, by the one or more hardware processors through an AI-based reasoning subsystem, the one or more rule-based prompts by performing one or more generative-reasoning operations to generate one or more analytical responses. The one or more generative-reasoning operations comprise at least one of: prompt interpretation, contextual embedding, semantic reasoning, and natural-language generation.

In the next step, the Gen-AI-based method includes generating, by the one or more hardware processors through a model optimization subsystem, one or more optimization recommendations for the predictive AI model based on the one or more analytical responses and the structured assessment output to optimize the predictive AI model.

In another embodiment of the present disclosure, a Gen-AI-based system is disclosed. The Gen-AI-based system comprises the one or more hardware processors and is operatively connected to a memory unit. The memory unit comprises a set of instructions in form of a plurality of subsystems, configured to be executed by the one or more hardware processors. The plurality of subsystems comprises the ingestion subsystem, the model conversion subsystem, the model interpretation subsystem, the multidimensional assessment subsystem, the Gen-AI subsystem, the prompt management subsystem, the AI-based reasoning subsystem, and the model optimization subsystem.

In one aspect, the ingestion subsystem is configured to receive the predictive AI model in the one or more formats from the one or more model sources. The ingestion subsystem is configured to receive contextual model data associated with the predictive artificial intelligence (AI) model via a user interface from a user associated with a user profile.

In another aspect, the model interpretation subsystem is configured to generate the text-based model representation of the predictive AI model by performing at least one of: the parsing procedures, the extraction procedures, and the relationship-evaluation procedures.

In yet another aspect, the multidimensional assessment subsystem is configured to evaluate the predictive AI model using the text-based model representation by performing at least one of: the analytical procedures and the dimension-specific rule-matching procedures using the plurality of assessment dimensions, for generating the structured assessment output.

In another aspect, the Gen-AI subsystem is configured to at least one of: a) autonomously generate one or more assessment queries based on analysis of the text-based model representation of the predictive AI model and the structured assessment output; and b) receive the one or more assessment queries via the user interface from the user for determining model attributes of the predictive AI model.

In yet another aspect, the prompt management subsystem is configured to aggregate the text-based model representation, the contextual model data, and the one or more assessment queries into the aggregated prompt context. The prompt management subsystem is configured to embed the one or more prompt orchestration directives into the aggregated prompt context to generate one or more rule-based prompts.

In another aspect, the AI-based reasoning subsystem is configured to process the one or more rule-based prompts by performing the one or more generative-reasoning operations to generate the one or more analytical responses.

In another aspect, the model optimization subsystem is configured to generate the one or more optimization recommendations for the predictive AI model based on the one or more analytical responses and the structured assessment output to optimize the predictive AI model.

In another embodiment of the present disclosure, a non-transitory computer-readable storage medium storing the set of instructions that, when executed by the one or more hardware processors, cause the one or more hardware processors to perform operations for optimizing the predictive AI model through multidimensional assessment, the operations comprising: a) receiving the predictive AI model in the one or more formats from the one or more model sources, and the contextual model data associated with the predictive AI model via the user interface from the user associated with the user profile, b) performing at least one of: the parsing procedures, the extraction procedures, and the relationship-evaluation procedures to generate the text-based model representation of the predictive AI model, c) performing at least one of: the analytical procedures and the dimension-specific rule-matching procedures using the plurality of assessment dimensions, for generating the structured assessment output to evaluate the predictive AI model using the text-based model representation, d) autonomously generating the one or more assessment queries based on analysis of the text-based model representation of the predictive AI model and the structured assessment output, e) receiving the one or more assessment queries via the user interface from the user to determine model attributes of the predictive AI model, f) aggregating the text-based model representation, the contextual model data, and the one or more assessment queries into the aggregated prompt context, g) embedding the one or more prompt orchestration directives into the aggregated prompt context to generate the one or more rule-based prompts, h) processing the one or more rule-based prompts by performing the one or more generative-reasoning operations to generate the one or more analytical responses, and i) generating the one or more optimization recommendations for the predictive AI model based on the one or more analytical responses and the structured assessment output to optimize the predictive AI model.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting a Gen-AI-based system for optimizing a predictive AI model through multidimensional assessment, in accordance with an embodiment of the present disclosure;

FIG. 2 illustrates an exemplary block diagram representation of the Gen-AI-based system as shown in FIG. 1 for optimizing the predictive AI model through the multidimensional assessment, in accordance with an embodiment of the present disclosure;

FIG. 3 illustrates an exemplary flowchart of the Gen-AI-based method for optimizing the predictive AI model through the multidimensional assessment, in accordance with an embodiment of the present disclosure; and

FIG. 4 illustrates an exemplary block diagram representation of one or more server platforms for optimizing the predictive AI model through the multidimensional assessment, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a" does not, without more constraints, preclude the existence of other devices, sub-systems, additional sub-modules. Appearances of the phrase "in an embodiment”, "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

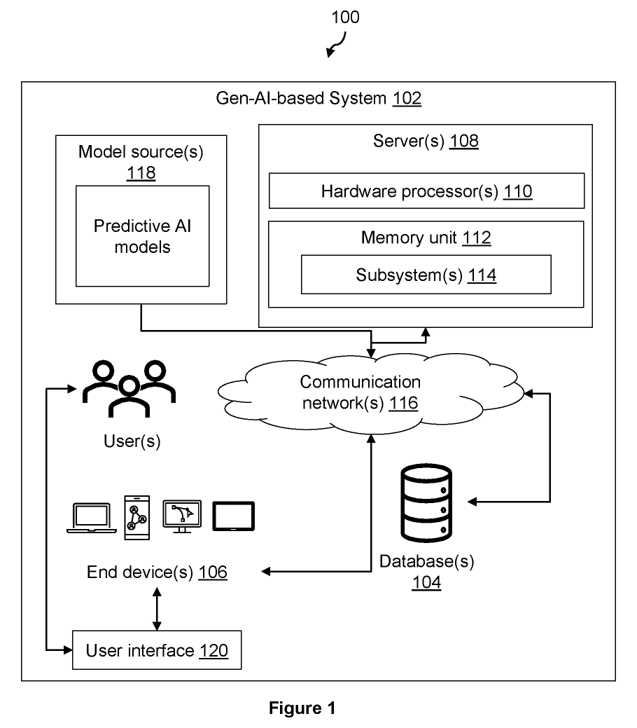

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

Unlike conventional computer-implemented systems that rely solely on static rule execution or deterministic evaluation logic, the Gen-AI-based system disclosed herein incorporates generative reasoning capabilities as an integral operational component. In particular, the system utilizes the Gen-AI to autonomously generate assessment queries based on analysis of a text-based model representation and a structured assessment output, and further employs an AI-based reasoning configured to process rule-based prompts by performing one or more generative-reasoning operations such as prompt interpretation, contextual embedding, semantic reasoning, and natural-language generation. These generative capabilities enable dynamic, context-aware analysis of predictive AI models that cannot be achieved through conventional rule-based architectures. Accordingly, the disclosed system is described herein as “Gen-AI-based” to reflect the indispensable role of generative artificial intelligence in driving the interpretation, assessment, reasoning, and optimization operations performed within the disclosed architecture.

As used herein, the term “predictive AI model” refers to any AI or machine-learning (ML) model that generates one or more predictions, classifications, scores, or decision outputs based on input data, and that may be represented in one or more model formats including, but not limited to, a predictive model markup language (PMML) file format, an extensible markup language (XML) file format containing PMML content, or a serialized machine-learning model file format. The predictive AI model may comprise model components such as input fields, feature definitions, transformation logic, preprocessing steps, statistical parameters, threshold conditions, scoring rules, and output specifications. The predictive AI model may further include metadata, version identifiers, deployment constraints, business-context attributes, or governance-related information. In the context of the present disclosure, the predictive AI model is the subject of interpretation, multidimensional assessment, generative query analysis, prompt orchestration, AI-based reasoning, and model optimization operations performed by the plurality of subsystems described herein.

As used herein, the term “multidimensional assessment” refers to a structured and comprehensive evaluation of the predictive AI model across a plurality of distinct analytical dimensions that collectively characterize the model’s behavior, integrity, performance, and operational suitability. Such assessment may incorporate analytical procedures, dimension-specific rule-matching procedures, and evaluation criteria that examine aspects including, but not limited to, feature coverage, transformation consistency, model-logic structure, sensitive-attribute usage, complexity indicators, output behavior, business alignment, data quality, model engineering practices, model governance factors, decision-system integrity, environmental considerations, and social impact factors. The multidimensional assessment may generate a structured assessment output that captures strengths, deficiencies, risks, and performance characteristics of the predictive AI model mapped to the respective assessment dimensions. In the context of the present disclosure, the multidimensional assessment serves as an intermediate analytical process that informs generative query creation, AI-based reasoning, and subsequent optimization of the predictive AI model.

FIG. 1 illustrates an exemplary block diagram representation of a network architecture 100 depicting a Gen-AI-based system 102 for optimizing the predictive AI model through multidimensional assessment, in accordance with an embodiment of the present disclosure.

According to an exemplary embodiment of the present disclosure, FIG. 1 depicts the network architecture 100 may include the Gen-AI-based system 102, one or more databases 104, one or more end devices 106, one or more model sources 118. The Gen-AI-based system 102, the one or more databases 104, the one or more end devices 106, the one or more model sources 118 may be communicatively coupled via one or more communication networks 116, ensuring seamless data transmission, processing, and multidimensional model assessment. The Gen-AI-based system 102 acts as a central processing unit within the network architecture 100, responsible for optimizing the predictive AI model through multidimensional assessment. The Gen-AI-based system 102 is configured to execute a set of computer-readable instructions that control a plurality of subsystems 114.

In an exemplary embodiment, the Gen-AI-based system 102 may include one or more servers 108 communicatively coupled to the one or more databases 104, the one or more end devices 106, and the one or more model sources 118 through the one or more communication networks 116. The one or more servers 108 may comprise a combination of discrete components, an integrated circuit, an application-specific integrated circuit, a field-programmable gate array, a digital signal processor, or other suitable one or more hardware processors 110 and a software. The “software” may comprise one or more objects, agents, threads, lines of code, subroutines, separate software applications, two or more lines of code, or other suitable software structures operating in one or more software applications or the one or more hardware processors 110. The one or more servers 108 comprises the one or more hardware processors 110 and a memory unit 112. The memory unit 112 is operatively connected to the one or more hardware processors 110. The memory unit 112 comprises a set of computer-readable instructions in form of the plurality of subsystems 114, configured to be executed by the one or more hardware processors 110. The one or more servers 108 may be implemented as physical machines, virtual machines, cloud instances, or a combination thereof, depending on a deployment architecture.

In an exemplary embodiment, the one or more hardware processors 110 may be configured to execute the set of instructions stored in the memory unit 112. The one or more hardware processors 110 may include one or more processing cores, such as, but not limited to, one of: central processing units (CPUs), graphical processing units (GPUs), tensor processing units (TPUs), neural processing units (NPUs), and the like, which facilitate high-performance computing and parallelized machine learning operations. The one or more hardware processors 110 may further execute software instructions related to model interpretation, multidimensional assessment, guardrail embedding, and optimizing the predictive AI model.

In an exemplary embodiment, the memory unit 112 may include any suitable computer-readable storage medium, such as, but not limited to, one of: a random-access memory (RAM), a read-only memory (ROM), a flash memory, hard disk drives, solid-state drives, and the like. The memory unit 112 may store program instructions, configuration parameters, model weights, vulnerability data, adversarial prompt sets, and generated exploit surface maps. The memory unit 112 may also store training datasets and alignment datasets used during secure fine-tuning operations.

In one exemplary embodiment, the plurality of subsystems 114 may include executable components that collectively perform the steps for fortifying the generative AI model. The plurality of subsystems 114 may include an ingestion subsystem, a model conversion subsystem, a model interpretation subsystem, a multidimensional assessment subsystem, a Gen-AI subsystem, a prompt management subsystem, an AI-based reasoning subsystem, and a model optimization subsystem. Each subsystem of the plurality of subsystems 114 may execute distinct but interdependent functions as defined in further embodiments, enabling optimization of the predictive AI models through the multidimensional assessment.

In one exemplary embodiment, the one or more databases 104 may serve as repositories for structured and unstructured data. In some embodiments, the one or more databases 104 may store information associated with the predictive AI models, including model files in various formats, contextual model data, and metadata received from the user. The one or more databases 104 may also maintain intermediate and derived information generated during operation of the Gen-AI-based system 102, such as text-based model representations, structured assessment outputs, generative assessment queries, aggregated prompt contexts, rule-based prompts, analytical responses, and optimization recommendations. In certain embodiments, the one or more databases 104 may further store historical assessments, user-interaction logs, system-generated reasoning traces, and configuration parameters used by the plurality of subsystems 114. The one or more databases 104 may be implemented using relational, non-relational, distributed, or cloud-based storage technologies and may be accessible to the Gen-AI-based system 102 through the one or more communication networks 116. The one or more databases 104 may be, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, and object storage systems (e.g., Amazon® S3, PostgresDB).

In an exemplary embodiment, the one or more communication networks 116 may include, but not limited to, wired networks, wireless networks, local area networks (LANs), wide area networks (WANs), cellular networks, and cloud-based communication channels. The one or more communication networks 116 may facilitate real-time data exchange between the Gen-AI-based system 102, the one or more databases 104, the one or more end devices 106, and the one or more model sources 118. In one embodiment, the one or more communication networks 116 may utilize standard communication protocols, including Transmission Control Protocol / Internet Protocol (TCP/IP), Hypertext Transfer Protocol (HTTP), Hypertext Transfer Protocol Secure (HTTPS), and message queuing protocols, to ensure reliable and secure data exchange between the components of the Gen-AI-based system 102.

In an exemplary embodiment, the one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the one or more model sources 118 may include internal or external repositories from which the predictive AI model are acquired. These one or more model sources 118 may store the predictive AI models in various formats, including the PMML file format, the XML file format containing PMML content, or the serialized machine-learning model file format. In certain embodiments, the one or more model sources 118 may comprise enterprise model registries, cloud-based model storage services, version-controlled repositories, or local file systems accessible by the user. The one or more model sources 118 may provide the predictive AI models to the Gen-AI-based system 102 for subsequent ingestion, interpretation, multidimensional assessment, and optimization through one or more communication networks 116. In some embodiments, the one or more model sources 118 may further supply associated model artifacts, metadata, or configuration files that support downstream analytical and reasoning operations performed by the plurality of subsystems 114.

In one exemplary embodiment, the one or more end devices 106 may represent any user interface devices, including, but not limited to, one of: desktop computers, laptops, mobile devices, tablets, and the like, through which the user may access, monitor, or interact with the Gen-AI-based system 102. In one embodiment, the one or more end devices 106 may configured with a user interface 120 allowing the users to provide the predictive AI model in one or more formats, supply contextual model data, and submit one or more assessment queries for processing by the Gen-AI-based system 102. The user interface 120 may further enable the users to review generated analytical responses, inspect the structured assessment output, and receive one or more optimization recommendations produced by the plurality of subsystems 114. In some embodiments, the user interface 120 may support real-time interactions, visualization of assessment insights, and display of system-generated reasoning artifacts.

In operation, the network architecture 100 enables communication and data exchange among the one or more end devices 106, the one or more model sources 118, the one or more databases 104, and the Gen-AI-based system 102 through the one or more communication networks 116. The network architecture 100 facilitates the transfer of the predictive AI models and the contextual model data from the one or more model sources 118 and the user via the user interface 120 to the Gen-AI-based system 102, as well as transmission of intermediate and resulting data generated during processing. The network architecture 100 further supports bidirectional interaction between the user and the Gen-AI-based system 102, enabling the users to submit the one or more assessment queries, receive the one or more optimization recommendations, and review the one or more optimization recommendations, through the one or more end devices 106. In certain embodiments, the network architecture 100 may additionally provide interoperable connectivity for accessing distributed storage resources, invoking remote reasoning operations, or synchronizing system-related information stored within the one or more databases 104.

In an exemplary embodiment, the Gen-AI-based system 102 may be implemented by way of a single device or a combination of multiple devices that may be operatively connected or networked together. The Gen-AI-based system 102 may be implemented in hardware or a suitable combination of hardware and software.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the Gen-AI-based system 102, and the one or more end devices 106 connected to the one or more databases 104, one skilled in the art can envision that the Gen-AI-based system 102, and the one or more end devices 106 may be connected to several user devices located at various locations and several databases via the one or more communication networks 116.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the Gen-AI-based system 102 as is unique to the present disclosure or necessary for an understanding of the present disclosure is depicted and described. The remainder of the construction and operation of the Gen-AI-based system 102 may conform to any of the various current implementations and practices that were known in the art.

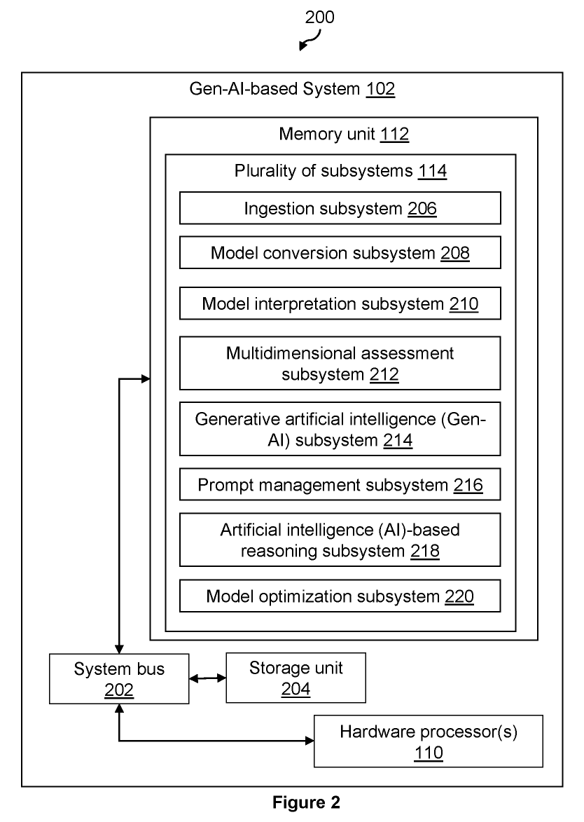

FIG. 2 illustrates an exemplary block diagram representation 200 of the Gen-AI-based system 102 as shown in FIG. 1 for optimizing the predictive AI model through the multidimensional assessment, in accordance with an embodiment of the present disclosure.

In an exemplary embodiment, the Gen-AI-based system 102 (hereinafter referred to as the system 102) comprises the one or more servers 108 that include the one or more hardware processors 110, the memory unit 112, and a storage unit 204. The one or more hardware processors 110, the memory unit 112, and the storage unit 204 are communicatively coupled through a system bus 202 or any analogous interconnect mechanism. The system bus 202 may function as a high-performance communication backbone that enables coordinated data exchange among these components. In certain embodiments, the system bus 202 may support high-speed interconnect standards such as Peripheral Component Interconnect Express (PCIe), Serial Advanced Technology Attachment (SATA), or similar communication protocols to accommodate the computational demands associated with processing the predictive AI models, text-based model representations, the aggregated prompt contexts, and generative-reasoning operations. The system bus 202 thereby facilitates efficient transfer of instructions, intermediate outputs, and data structures required for the operation of the plurality of subsystems 114, ensuring that the system 102 is able to perform ingestion, interpretation, multidimensional assessment, prompt management, AI-based reasoning, and model optimization in a synchronized and scalable manner.

In an exemplary embodiment, the memory unit 112 is operatively connected to the one or more hardware processors 110 through the system bus 202. The memory unit 112 stores the plurality of subsystems 114 in the form of the set of instructions configured to be executed by the one or more hardware processors 110. The plurality of subsystems 114 may include, but is not limited to, the ingestion subsystem 206, the model conversion subsystem 208, the model interpretation subsystem 210, the multidimensional assessment subsystem 212, the generative artificial intelligence (Gen-AI) subsystem 214, the prompt management subsystem 216, the artificial intelligence (AI)-based reasoning subsystem 218, and the model optimization subsystem 220. Each subsystem operates in conjunction with the others to enable ingestion, interpretation, multidimensional assessment, generative reasoning, and optimization of the predictive AI model within the system 102.

The one or more hardware processors 110 associated with the one or more servers 108, as used herein, may represent any type of computational circuit configured to execute machine-readable instructions. The one or more hardware processors 110 may include, but not limited to, a microprocessor unit (MPU), a microcontroller unit (MCU), a central processing unit (CPU), a graphics processing unit (GPU), a tensor processing unit (TPU), a digital signal processor (DSP), a reduced instruction set computing (RISC) processor, a complex instruction set computing (CISC) processor, a very long instruction word (VLIW) processor, or any other suitable processing circuit. The one or more hardware processors 110 may also include embedded controllers, programmable logic devices (PLDs), application-specific integrated circuits (ASICs), field-programmable gate arrays (FPGAs), system-on-chip (SoC) architectures, or other types of configurable logic capable of executing the plurality of subsystems 114 to perform the ingestion, interpretation, multidimensional assessment, generative query generation, prompt management, AI-based reasoning, and model optimization operations described herein.

In an exemplary embodiment, the memory unit 112 may include one or more types of non-transitory memory, such as volatile memory and non-volatile memory. The memory unit 112 may be operatively connected to the one or more hardware processors 110 and may serve as a computer-readable storage medium configured to store machine-readable instructions, data structures, and configuration parameters utilized by the system 102. The machine-readable instructions stored within the memory unit 112 may implement the plurality of subsystems 114, including instructions for performing ingestion of predictive AI models, generating the text-based model representation, executing multidimensional assessment operations, generating the one or more assessment queries, constructing rule-based prompts, performing AI-based generative reasoning, and producing optimization recommendations. The one or more hardware processors 110 may execute the machine-readable instructions stored in the memory unit 112 to perform the coordinated operations of the plurality of subsystems 114 as described herein.

A variety of machine-readable instructions may be stored in and accessed from the memory unit 112, including but not limited to instructions for receiving predictive AI models and the contextual model data, generating the text-based model representation, performing the multidimensional assessment operations, generating or receiving the one or more assessment queries, constructing the aggregated prompt contexts, embedding one or more prompt orchestration directives, executing generative-reasoning operations, and producing the one or more optimization recommendations for the predictive AI model.

The memory unit 112 may include, without limitation, read-only memory (ROM), random-access memory (RAM), cache memory, flash memory, programmable read-only memory (PROM), erasable programmable read-only memory (EPROM), electrically erasable programmable read-only memory (EEPROM), solid-state drives (SSD), or other forms of non-transitory memory. The memory unit 112 may also include or interface with one or more removable storage media such as hard drives, optical storage devices, memory cards, or magnetic storage cartridges for persistent data retention. The memory unit 112 stores the plurality of subsystems 114 in the form of machine-readable instructions executable by the one or more hardware processors 110, wherein execution of the plurality of subsystems 114 enables the system 102 to perform ingestion, interpretation, multidimensional assessment, generative query formulation, prompt management, AI-based reasoning, and model optimization operations in a coordinated and computationally efficient manner.

In an exemplary embodiment, the storage unit 204 may include one or more persistent data repositories, which may be implemented using cloud storage systems, local storage devices, or the one or more databases 104 illustrated in FIG. 1. The storage unit 204 may be configured to store various data elements generated or utilized by the system 102, including, but not limited to, predictive AI model files received from the one or more model sources 118, the contextual model data provided by the user, the text-based model representations generated by the model interpretation subsystem 210, structured assessment outputs produced by the multidimensional assessment subsystem 212, and the one or more assessment queries generated or received by the Gen-AI subsystem 214. In some embodiments, the storage unit 204 may also store the aggregated prompt contexts, prompt orchestration directives, rule-based prompts, analytical responses produced by the AI-based reasoning subsystem 218, and the one or more optimization recommendations generated by the model optimization subsystem 220. These stored data elements may enable historical tracking of assessments, comparison of model evaluations across versions, reuse of analytical artifacts, and validation of optimization improvements performed over multiple assessment cycles.

In certain exemplary embodiments, the storage unit 204 may also maintain prior versions of the predictive AI models, the associated contextual model data, and previously generated structured assessment outputs to support rollback operations, regression analysis, or version-controlled model evaluation. Additionally, the storage unit 204 may store configuration data and reference information used by the plurality of subsystems 114, such as assessment dimension definitions, analytical rule sets, prompt orchestration directives, generative query templates, and historical analytical responses. These stored elements enable continuous refinement of assessment workflows, allow comparison of optimization recommendations across multiple iterations, and support consistent auditability and reproducibility of the model assessment and optimization processes performed by the system 102.

The storage unit 204 may be implemented using one or more database technologies, including but not limited to relational databases, distributed databases, graph databases, cloud-native databases, or any other suitable persistent storage mechanism. In certain embodiments, the storage unit 204 may further employ scalable storage architectures such as Network Attached Storage (NAS), Storage Area Networks (SAN), or object-based cloud storage services to accommodate the storage and retrieval of large volumes of predictive AI model files, the contextual model data, the text-based model representations, the structured assessment outputs, the prompt-related artifacts, and analytical responses. Such scalable storage configurations may support enterprise-level deployment of the system 102 by enabling efficient management of high-dimensional model artifacts, historical assessment records, and optimization recommendations generated across multiple evaluation cycles.

In an exemplary embodiment, the ingestion subsystem 206 is configured to receive the predictive AI model in the one or more formats from the one or more model sources 118. The ingestion subsystem 206 functions as the primary entry point through which the predictive AI model files and supplementary contextual information required for downstream analysis are collected, validated, normalized, and prepared for subsequent operations performed by the remaining subsystems of the system 102.

The predictive AI model in the one or more formats comprises, but not limited to, one of: the PMML file format, the XML file format containing the PMML content, and the serialized machine-learning model file format such as a scikit-learn pickle (.pkl) file. When the user provides the serialized machine-learning model file format, the ingestion subsystem 206 performs controlled deserialization under a restricted execution environment to prevent loading of unsafe or arbitrary Python objects. In such exemplary embodiments, only recognized estimator types such as scikit-learn Pipelines, ColumnTransformers, or supported built-in estimators are permitted for loading. After safe deserialization, the ingestion subsystem 206 triggers a conversion process that transforms the serialized machine-learning model into the PMML file format. The conversion process may rely on a model-translation framework, such as sklearn2pmml, to extract the estimator structure, hyperparameters, transformation logic, feature lineage information, scoring behavior, and any pre-processing steps or post-processing steps applied to the predictive AI model. If the predictive AI model includes unsupported custom transformers or bespoke set of rules, the ingestion subsystem 206 generates a hybrid representation that may include auxiliary Open Neural Network Exchange (ONNX) or JavaScript Object Notation (JSON) structures along with a compatibility notification, thereby allowing the remaining subsystems to operate despite partial conversion.

When the predictive AI model is received in the PMML file format or XML-based PMML content, the ingestion subsystem 206 performs schema validation to ensure structural integrity of the uploaded document. In such exemplary embodiments, the ingestion subsystem 206 verifies the presence and correctness of required PMML components, such as MiningModel, MiningSchema, Node hierarchies, transformation dictionaries, ScoreDistribution definitions, and OutputField declarations. The ingestion subsystem 206 further verifies data-type consistency, evaluates structural completeness, and performs pre-processing checks to ensure that the PMML or XML file adheres to expected PMML schema definitions. After successful validation, the PMML content is accepted as a machine-readable structured representation suitable for subsequent model interpretation.

As used herein, the MiningModel refers to the PMML construct that defines the overall predictive model structure, including the type of model and how multiple model components are combined during scoring. The MiningSchema denotes a schema specification that declares all input fields, target fields, and derived fields required for model execution, along with their usage types and operational roles. The Node hierarchies refers to a tree-structured arrangement of decision nodes and leaf nodes commonly used in decision tree and ensemble models, where each node specifies a split condition and each leaf represents a score or outcome. The transformation dictionaries refer to PMML sections that describe preprocessing or feature engineering transformations applied to raw input fields, including normalization, discretization, mapping, or expression-based derivation. The ScoreDistribution definitions refers to PMML structures that specify probability distributions, confidence values, or class-level statistics associated with a predicted outcome. The OutputField declarations refers to the model-defined output elements that describe the predictions, probabilities, confidence metrics, or other derived results produced during model scoring.

In addition to the predictive AI model, The ingestion subsystem 206 also receives the contextual model data associated with the predictive AI model via the user interface 120 from the user associated with the user profile. The contextual model data comprises, but not limited to, at least one of model metadata, model version information, feature descriptions, training dataset characteristics, commercial context parameters, performance metrics, model governance attributes, deployment environment information, usage constraints, intended application details, and the like. This contextual model data supplements structural and behavioral characteristics of the predictive AI model by providing environmental conditions, operational constraints, and domain-specific considerations that influence how the predictive AI model is interpreted and assessed. For example, a user may provide information such as the training window of the dataset, the business objective underlying the model, the field-level meaning of each feature, and the conditions under which the model is deployed in a real-time environment. Such contextual model data serves as a semantic enhancement to the underlying model artifact and is used in later stages to guide the generation of the one or more assessment queries, dimension-specific analyses, and the one or more optimization recommendations.

As used herein, the model metadata refers to descriptive information about the predictive AI model, including its name, type, creation date, and authoring details. The model version information denotes identifiers or labels specifying the evolutionary state of the predictive AI model across iterations or releases. The feature descriptions refers to semantic explanations of the input variables used by the predictive AI model, including their meaning, data types, and operational intent. The training dataset characteristics refers to properties of the dataset used to train the predictive AI model, including dataset size, time range, feature distributions, sampling assumptions, and class balance. The commercial context parameters refer to business-specific factors or operational settings, such as market segment, domain purpose, or economic constraints that influence model usage. The performance metrics denotes quantitative measures of model effectiveness, including accuracy, precision, recall, area under a receiver operating characteristic (ROC) curve, or domain-specific key performance indicators (KPIs). The model governance attributes refer to compliance-related information, such as validation history, approval records, audit identifiers, and applicable regulatory requirements. The deployment environment information denotes technical settings describing where and how the predictive AI model is executed, including system architecture, latency requirements, throughput constraints, and integration endpoints. The usage constraints refer to limitations or boundaries imposed on model operation, such as prohibited use cases, data exclusions, or ethical restrictions. The intended application details refer to the specific operational purpose for which the predictive AI model is designed, such as risk scoring, forecasting, classification, or decision support within a defined domain.

In certain embodiments, the ingestion subsystem 206 incorporates safety and structural integrity mechanisms that evaluate the validity of each uploaded model file. The ingestion subsystem 206 may verify that the uploaded model file adheres to a recognized file type, that file size and structural characteristics fall within acceptable limits, and that the content does not contain malicious constructs or corrupted structures. During these validation steps, the ingestion subsystem 206 may examine element consistency in the PMML, check for missing feature declarations, evaluate the integrity of transformation pipelines, and apply schema verification procedures to XML-based PMML content. For serialized machine-learning models, the ingestion subsystem 206 performs safe loading protocols to detect and prevent the existence of unsafe opcodes or unexpected Python object types.

In an exemplary embodiment, the model conversion subsystem 208 is configured to convert the one of: the XML file format containing the PMML content, and the serialized machine-learning model file format, into the PMML file format. The model conversion subsystem 208 enables the system 102 to internally operate on predictive AI models in a uniform representation by transforming heterogeneous predictive AI model formats into a standardized PMML structure. The model conversion subsystem 208 therefore provides an essential normalization function that allows subsequent subsystems, including the model interpretation subsystem 210 and the multidimensional assessment subsystem 212, to process and analyze predictive AI models in a consistent manner regardless of their original source or file format.

In one exemplary embodiment, when the predictive AI model is received in the serialized machine-learning model file format, such as a scikit-learn pickle (.pkl) file, the model conversion subsystem 208 initiates a controlled deserialization process. As used herein, controlled deserialization refers to a restricted loading procedure that prevents arbitrary object execution by limiting deserialization to known, approved estimator types such as scikit-learn regression models, classification models, ensemble estimators, pipelines, and transformation components. This safety mechanism ensures that no malicious or unrecognized Python object is instantiated during model loading. After the predictive AI model is safely deserialized, the model conversion subsystem 208 extracts the constituent elements of the model, including but not limited to the estimator type, hyperparameters, learned statistical parameters, transformation pipelines, and preprocessing logic.

When the predictive AI model is received in the XML file format containing the PMML content, the model conversion subsystem 208 performs a structural normalization procedure. As used herein, the structural normalization procedure refers to validating the XML against PMML schema definitions, ensuring that the XML structure is well-formed, resolving namespace inconsistencies, and correcting minor structural deviations to comply with the expected PMML file format. Examples of such normalization include resolving missing schema declarations, adjusting data type inconsistencies, or reordering PMML elements to comply with standard PMML specification ordering. Once normalization is complete, the XML content is converted into a canonical PMML file format suitable for downstream processing.

In all embodiments, the model conversion subsystem 208 ensures that the output PMML file format accurately reflects the predictive AI model’s structure, its feature definitions, transformation logic, scoring mechanisms, and output specifications. The converted PMML file format is then supplied to the model interpretation subsystem 210 for further processing, including the generation of the text-based model representation.

In certain exemplary embodiments, the system 102 further comprises a conversion-management routine executed by the model conversion subsystem 208 for translating the serialized machine-learning model file formats into the PMML file format. The model conversion subsystem 208 includes an adapter layer configured to interface with third-party conversion libraries such as sklearn2pmml, JPMML, and custom-built model-to-PMML translators. The adapter layer performs estimator-structure introspection, extraction of hyper-parameters, reconstruction of transformation pipelines, and validation of feature lineage prior to translation. When one or more components of the predictive AI model are unsupported by standard PMML exporters, such as custom scikit-learn transformers, Python function transformers, or vendor-specific estimators, the model conversion subsystem 208 automatically generates a hybrid representation consisting of a primary PMML file supplemented by an Extensions block encoding unsupported logic, and an auxiliary ONNX or JSON-based computational graph. A compatibility report is concurrently generated describing unsupported operators, recommended remediation steps, and the potential impact on downstream analysis.

In an exemplary embodiment, the model interpretation subsystem 210 is configured to generate the text-based model representation of the predictive AI model by performing at least one of: parsing procedures, extraction procedures, and relationship-evaluation procedures. The model interpretation subsystem 210 serves as the component within the system 102 that transforms the PMML file format associated with the predictive AI model, together with the contextual model data, into a human-readable and semantically enriched textual description suitable for downstream multidimensional assessment and generative AI–driven reasoning. The text-based model representation produced by this model interpretation subsystem 210 provides a structured and interpretable articulation of the predictive AI model’s internal logic, structural configuration, and operational behavior.

In one exemplary embodiment, the parsing procedures comprise processing the PMML file format associated with the predictive AI model together with the contextual model data to identify parsed model elements comprising at least one of: a model type, input fields, transformation logic, decision logic, and output specifications. The model type refers to a category of predictive AI model encoded in the PMML file format, such as, but not limited to, at least one of: a regression model, a tree model, a MiningModel, a neural network model, and the like. The input fields refer to the feature variables declared in the MiningSchema of the PMML, each associated with data types, operational roles, and usage attributes. The transformation logic refers to preprocessing operations defined in the TransformationDictionary, such as normalization operations, discretization bins, expression-based transformations, or mapping tables. The decision logic refers to the decision-making structure encoded in PMML components such as Node hierarchies in the tree models or coefficient expressions in the regression models. The output specifications refer to output field declarations that identify the scoring results, predicted classes, probabilities, confidence measures, or intermediate outputs generated by the predictive AI model.

During the parsing procedures, the model interpretation subsystem 210 decodes the hierarchical XML structure of the PMML and constructs an internal intermediate representation of each parsed model element. In one enablement example, when processing a PMML representation of a scoring pipeline with both transformations and a classifier, the model interpretation subsystem 210 parses the TransformationDictionary to extract a chain of functions that convert raw input fields into derived fields, then parses the MiningModel element to identify embedded models such as ensemble components or chained sub-models. During this process, contextual model data is merged with PMML-derived information to enrich the interpretation. For example, if contextual model data specifies that a feature “income_annum” refers to annual income of a loan applicant, the model interpretation subsystem 210 integrates that label into the parsed representation of the corresponding input field.

In an exemplary embodiment, the extraction procedures comprise retrieving predictive AI model components comprising, but not limited to, at least one of: feature definitions, statistical parameters, threshold conditions, preprocessing steps, scoring rules, and the like, from the parsed model elements. The feature definitions refer to semantic and structural descriptions of the input fields, including their role (active, supplementary, target), type, and encoding. The statistical parameters refer to learned model values such as regression coefficients, tree split values, or centroids in clustering models. The threshold conditions refer to decision rules embedded in tree nodes or logical expressions, including inequality splits and categorical selection conditions. The preprocessing steps refer to the operational transformations applied prior to model scoring, such as normalization formulas or encoding tables. The scoring rules refer to the computational logic used to generate the model’s output, such as summing weighted inputs in a regression model or traversing a Node hierarchy in the tree model.

For instance, when a random forest classifier is represented in PMML, the model interpretation subsystem 210 extracts each tree’s structure, including the decision conditions at each internal node, the feature used for splitting, the threshold value, and the class distributions stored in each leaf node. Similarly, for a PMML-based logistic regression model, the model interpretation subsystem 210 extracts the coefficient vector, the intercept term, and the link function details to produce the text-based explanation that expresses the scoring rule in mathematical or narrative form.

In an exemplary embodiment, the relationship-evaluation procedures comprise analyzing relationships among the parsed model elements and the extracted predictive AI model components to identify at least one of: feature-to-prediction dependencies, transformation chains, and scoring flows. The feature-to-prediction dependencies refer to a structural and statistical relationships that describe how specific input fields influence intermediate transformations or final prediction outcomes. The transformation chains refer to sequences of preprocessing operations applied to an input field prior to scoring, such as a normalization followed by a one-hot encoding, and represent the operational lineage from raw inputs to derived fields. The scoring flows refer to the end-to-end logical path through which input data propagates during model evaluation, including traversal through model subcomponents, ensemble voting structures, or layered decision logic.

For instance, the model interpretation subsystem 210 identifies that an input field such as “loan_amount” undergoes a series of operations including log transformation, standard scaling, and categorical transformation prior to being used as part of a decision-tree split. The model interpretation subsystem 210 then expresses this as a natural-language description such as: “The feature loan_amount influences prediction outcomes through a transformation chain comprising log-scaling followed by normalization, and contributes to decision splits in 14 of 100 trees.” This operational trace forms part of the text-based model representation.

The final output of the model interpretation subsystem 210 is a comprehensive, readable, and logically structured text-based model representation that captures the predictive AI model’s structure, behavior, transformations, scoring logic, and operational dependencies.

In an exemplary embodiment, the multidimensional assessment subsystem 212 is configured to evaluate the predictive AI model using the text-based model representation by performing at least one of: the analytical procedures and the dimension-specific rule-matching procedures using the plurality of assessment dimensions, for generating the structured assessment output. The multidimensional assessment subsystem 212 functions as the core analytical engine within the system 102 that systematically examines the predictive AI model across technical, operational, and contextual axes to produce a comprehensive, explainable, and structured assessment of the model’s strengths, deficiencies, and risks. This multidimensional assessment subsystem 212 operates directly on the text-based model representation generated by the model interpretation subsystem 210, thereby enabling rule-based, context-sensitive, and explainable evaluation without direct execution of the predictive AI model.

In an exemplary embodiment, the analytical procedures comprise, but not limited to, at least one of: identifying feature coverage, transformation consistency, model logic structure, sensitive-attribute usage, complexity indicators, and output behavior. The identifying feature coverage refers to determining whether the predictive AI model utilizes all declared input fields, whether certain features exert disproportionate influence, and whether unused or redundant features are present. This analysis uses the extracted representation of feature-to-prediction dependencies and transformation chains. For example, the multidimensional assessment subsystem 212 may identify that the predictive AI model includes 48 declared features but uses only 17 for decision splits, thereby flagging potential underutilization.

The transformation consistency refers to verifying that all preprocessing steps applied to input fields follow expected semantic and logical patterns, including correct handling of missing values, proper alignment between categorical encoding and domain definitions, and consistency between declared feature descriptions and applied transformations. For instance, if a feature described in contextual model data as “monthly income” is transformed using an annual scaling factor, the multidimensional assessment subsystem 212 flags an inconsistency indicating a possible error in transformation logic.

The model logic structure refers to the evaluation of the decision-making configuration of the predictive AI model, such as the coherence of Node hierarchies in the tree model, the interpretability of regression coefficients in a linear model, or the ensemble composition in the mining model. The multidimensional assessment subsystem 212 detects structural anomalies such as excessively deep trees, circular transformation references, or unusual weighting of ensemble sub-models.

The sensitive-attribute usage refers to determining whether protected or regulated attributes such as age, gender, race, postal codes, or proxies of sensitive variables appear in feature definitions, transformation chains, or decision logic. The multidimensional assessment subsystem 212 compares feature names, derived fields, and transformation expressions with known patterns of sensitive attributes and identifies potential fairness or compliance risks. For example, the multidimensional assessment subsystem 212 may detect that the derived field “geo_segment” is strongly correlated with location-based sensitive attributes.

The complexity indicators refer to computation of metrics that reflect the model’s structural and computational complexity, such as the number of parameters, the number of decision nodes, depth of trees, number of derived fields, or the size of transformation graphs. High complexity may indicate potential challenges related to maintainability, interpretability, and deployment performance.

The output behavior refers to the evaluation of expected scoring patterns, confidence distributions, or decision pathways inferred from the scoring logic. For example, the multidimensional assessment subsystem 212 may identify that a binary classifier produces extremely skewed score distribution values, suggesting potential calibration issues.

In an exemplary embodiment, the dimension-specific rule-matching procedures comprise applying the plurality of assessment dimensions to the predictive AI model to generate deterministic, rubric-driven evaluations mapped to recognized industry, regulatory, or organizational standards. The plurality of assessment dimensions comprise at least one of: operational alignments, a data quality, model engineering, model governance, decision-system integrity, an environmental impact, and a social impact. The operational alignments refer to evaluating whether the predictive AI model is suitable for the deployment environment specified in the contextual model data, including latency tolerances, throughput requirements, or real-time versus batch scoring expectations.

The data quality refers to assessing the suitability and robustness of the training dataset characteristics, including data coverage, sampling strategies, class balance, and alignment between training and deployment data conditions. The multidimensional assessment subsystem 212 may flag mismatches, such as when the predictive AI model is trained on a pre-2020 dataset but is deployed in a post-2023 environment with materially changed feature distributions. The model engineering refers to evaluation of the technical construction of the predictive AI model, including transformation pipelines, parameterization strategies, feature engineering methods, and adherence to best practices in machine-learning engineering. The multidimensional assessment subsystem 212 may detect issues such as redundant transformation chains or unsupported transformation sequences based on the PMML file format.

The model governance refers to evaluating whether the predictive AI model aligns with at least one of. But not limited to, regulatory requirements, approval processes, versioning standards, or documentation practices indicated in the contextual model data. For example, if the contextual model data indicates that the model is a “version 3.2 production model” but no corresponding governance attributes are present, the multidimensional assessment subsystem 212 identifies a governance gap. The decision-system integrity refers to evaluating logical correctness, stability, and consistency of model decision paths or scoring flows. The decision-system may include detecting contradictory decision rules, unreachable nodes, or inconsistent score distributions across similarly conditioned nodes.

The environmental impact refers to evaluating computational load and resource utilization patterns inferred from model structure, such as, but not limited to, one of: processor requirements, memory footprint, energy efficiency implications associated with the model’s complexity, and the like. The social impact refers to evaluating how the model’s structure and usage of sensitive attributes may affect fairness, inclusivity, and equitable treatment, inferred from sensitive-attribute usage and transformation logic.

In one exemplary embodiment, the structured assessment output comprises at least one of: identified strengths, deficiencies, model risks, and performance characteristics of the predictive AI model mapped to the plurality of assessment dimensions. For example, the structured assessment output may state that the predictive AI model demonstrates strong operational alignments due to efficient scoring logic, but exhibits deficiencies in sensitive-attribute usage due to inferred correlations with location-based proxies. The structured assessment output is produced in a format configured for machine and human consumption, enabling downstream use by the Gen-AI subsystem 214 and the model optimization subsystem 220.

In an exemplary embodiment, the Gen-AI subsystem 214 is configured to at least one of: a) autonomously generate the one or more assessment queries based on analysis of the text-based model representation of the predictive AI model and the structured assessment output; and b) receive the one or more assessment queries via the user interface 120 from the user for determining model attributes of the predictive AI model. The Gen-AI subsystem 214 functions as the component of the system 102 responsible for formulating high-level interrogatives, prompts, and domain-specific questions that guide the deeper exploration and understanding of the predictive AI model. The Gen-AI subsystem 214 leverages generative artificial intelligence capabilities to enhance the analytical depth of the multidimensional assessment subsystem 212 by generating targeted assessment queries that reflect both the structural properties and the contextual significance of the predictive AI model.

In some embodiments, autonomous query generation is performed by analyzing the text-based model representation and the structured assessment output to identify at least one of: semantic gaps, ambiguous behaviors, areas requiring deeper explanation, and the like. As used herein, the text-based model representation refers to the human-readable narrative detailing the predictive AI model’s structure, transformations, decision logic, and feature dependencies. The Gen-AI subsystem 214 processes this narrative using natural-language understanding mechanisms to extract structural cues, such as unusual transformation chains, complex Node hierarchies, inconsistent threshold conditions, atypical feature usages, or high-sensitivity indicators. Based on these cues, the Gen-AI subsystem 214 generates the one or more assessment queries that seek clarification on model attributes including detailed characteristics, dependencies of the predictive AI model, the decision logic, the model risks, and model behaviors.

In one enablement example, if the structured assessment output indicates that the predictive AI model exhibits heavy reliance on a particular derived field, the Gen-AI subsystem 214 may autonomously generate an assessment query such as: “Explain how the derived field ‘credit_risk_segment’ influences the model’s overall prediction behavior.” Similarly, if the multidimensional assessment subsystem 212 identifies inconsistent transformation chains, the Gen-AI subsystem 214 may generate: “Why does the field ‘loan_amount’ undergo both log-scaling and z-normalization? Provide functional justification for this transformation sequence.” These queries are generated without user intervention and reflect analytical reasoning applied to the content derived from upstream subsystems.

The Gen-AI subsystem 214 also supports user-driven query submission. Through the user interface 120, the user may enter the one or more assessment queries to obtain deeper insights into the predictive AI model’s behavior or structure. In this context, the Gen-AI subsystem 214 interprets the user provided the one or more assessment queries, maps them to the corresponding components of the text-based model representation, and reformulates them into a structured format usable by the downstream prompt management subsystem 216. For example, a user may ask: “Which features contribute most to the prediction variability?” or “How does the model handle missing income values?” The Gen-AI subsystem 214 processes these natural-language questions by identifying relevant model attributes such as feature importance, decision logic, or transformation behavior, and prepares them for generative analysis.

In an exemplary embodiment, the model attributes comprise at least one of: detailed characteristics of the predictive AI model, dependencies of the predictive AI model, the decision logic, the model risks, and model behaviors. As used herein, the detailed characteristics refer to internal structural descriptions of the predictive AI model such as, but not limited to, model type, decision strategy, parameterization, transformation pipelines, and the like. The dependencies of the predictive AI model refer to relational mappings between input fields, derived fields, and decision-making flows. The decision logic refers to the explicit scoring rules, Node hierarchies, mathematical operations, and the like, that determine how predictions are generated. The model risks refer to vulnerabilities arising from model structure, such as sensitivity to certain feature subsets, potential fairness concerns, instability in scoring flows, and the like. The model behaviors refer to the expected or inferred outputs of the predictive AI model under varying input conditions, including monotonicity properties, threshold-driven behaviors, and probability distribution patterns embedded in the predictive AI model.

In an exemplary embodiment, the prompt management subsystem 216 is configured to aggregate the text-based model representation, the contextual model data, and the one or more assessment queries into the aggregated prompt context. The prompt management subsystem 216 operates as an orchestration layer responsible for constructing a complete, semantically consistent input structure that will be interpreted by the AI-based reasoning subsystem 218. The aggregated prompt context refers to a composite prompt framework that unifies model-specific information, user-provided context, and analytical intent into a single structured representation suitable for generative reasoning. This unified representation allows downstream generative operations to accurately interpret the predictive AI model’s characteristics and to reason over its structure based on both data-driven and context-driven cues.

Upon generating the aggregated prompt context, the prompt management subsystem 216 is configured to embed the one or more prompt orchestration directives into the aggregated prompt context to generate one or more rule-based prompts. The embedding of the one or more prompt orchestration directives enables the transformation of raw contextual information into an executable instruction set that can be interpreted by the AI-based reasoning subsystem 218 in a deterministic, constrained, and analysis-driven manner. The one or more prompt orchestration directives comprise at least one of: Gen-AI-based system instructions, output-format constraints, analysis directives, and response guardrails. As used herein, the Gen-AI-based system instructions refer to system-level directives that define the operational role, behavior, or constraints of the generative model, such as instructing the predictive AI model to act as a domain analyst, a model auditor, or a predictive-model evaluator. These instructions ensure that the generative engine adheres to the intended analytical perspective during execution.

The output-format constraints refer to explicit formatting specifications that dictate the structure, layout, or style in which the generative output must be returned. Such output-format constraints may include producing outputs in tabular form, bulletized summaries, JSON-formatted analytical blocks, structured narrative sections, and the like. The analysis directives refer to targeted instructions that instruct the AI-based reasoning subsystem 218 to perform specific types of reasoning operations, such as evaluating potential risks in the decision logic, identifying inconsistencies in transformation chains, or explaining feature-to-prediction dependencies. These one or more prompt orchestration directives narrow the reasoning scope and ensure relevance to the predictive AI model being analyzed.

The response guardrails refers to constraints and safety boundaries imposed on the generative model to maintain logical accuracy, prevent hallucinations, enforce factual grounding in the aggregated prompt context, and avoid generating unsupported statements. The response guardrails may include, but not limited to, at least one of: requirements such as citing extracted model fields, referencing only elements identified in the text-based model representation, explicitly declaring uncertainty when the information is incomplete, and the like. In some exemplary embodiments, the response guardrails also define failure modes, such as instructing the generative system to produce the statement “INSUFFICIENT INFORMATION TO ANSWER” if the aggregated prompt context does not contain the requested detail.

In one enablement example, when forming the aggregated prompt context, the prompt management subsystem 216 concatenates the text-based model representation (such as the PMML-derived narrative describing model type, transformation logic, and scoring rules), the contextual model data (such as feature descriptions and intended application details), and the one or more assessment queries generated by the Gen-AI subsystem 214. The prompt management subsystem 216 then embeds the one or more prompt orchestration directives into this combined structure, producing a rule-based prompt that may resemble a layered instruction sequence. The layered prompt may include: (a) a system instruction such as “You are an AI model assessment engine trained to generate precise analysis”; (b) a context block containing PMML-derived text segments; (c) a question block containing one or more assessment queries; and (d) a constraints block defining output format rules and guardrails. This layered construction ensures that the AI-based reasoning subsystem 218 receives a fully contextualized, tightly structured prompt with explicit analytical intent.

In some exemplary embodiments, the prompt management subsystem 216 applies additional formatting rules including delimiter fencing (such as triple-backtick boundaries) to isolate context blocks, few-shot exemplars to demonstrate expected output quality, and scoring rubrics that guide the AI-based reasoning subsystem 218 toward consistent evaluation. The AI-based reasoning subsystem 218 also ensures that prompt components are sequenced in an optimal order, system instructions first, followed by context, followed by the one or more assessment queries, and finally the output constraints, thereby enabling deterministic and reproducible generative reasoning results. The rule-based prompts generated by the prompt management subsystem 216 represent the finalized input structures used by the AI-based reasoning subsystem 218 to perform generative-reasoning operations.

In one exemplary embodiment, before transmitting the one or more rule-based prompts to the AI-based reasoning subsystem 218, the prompt management subsystem 216 applies sanitization procedures that detect and redact sensitive information within the contextual model data or model artifacts. Redaction rules include masking personally identifiable information, hashing feature names that contain regulated identifiers, removing raw sample values, and replacing sensitive fields with generic tokens. Sanitization is logged, and a sanitized context pack is stored alongside the unredacted version for auditability.

In an exemplary embodiment, the AI-based reasoning subsystem 218 is configured to process the one or more rule-based prompts by performing the one or more generative-reasoning operations to generate the one or more analytical responses. The AI-based reasoning subsystem 218 operates as the core inference engine of the system 102, responsible for transforming the structured prompt content generated by the prompt management subsystem 216 into meaningful, contextually accurate insights regarding the predictive AI model. As used herein, “the one or more analytical responses” refer to machine-generated natural-language or structured outputs that describe, explain, evaluate, or critique aspects of the predictive AI model based on the content embedded within the one or more rule-based prompts. The one or more analytical responses may include, but are not limited to, detailed explanations of model logic, identification of inconsistencies, detection of transformation anomalies, articulation of risks, and cross-dimensional assessments derived from the structured assessment output.

The one or more generative-reasoning operations comprise at least one of: prompt interpretation, contextual embedding, semantic reasoning, and natural-language generation. As used herein, the prompt interpretation refers to the process by which the AI-based reasoning subsystem 218 parses and understands the structure of the one or more rule-based prompts, including recognizing system instructions, context blocks, assessment queries, and output-format constraints. In one embodiment, the AI-based reasoning subsystem 218 may utilize a large language model (LLM) executing on a model orchestration engine (such as an Ollama-based backend) to convert the structured prompt into an internal representation that guides downstream reasoning steps. The prompt interpretation ensures that the AI-based reasoning subsystem 218 correctly identifies what is being asked, what information is available, and which constraints govern the response generation.

The contextual embedding, as used herein, refers to the operation of encoding the aggregated prompt context, including the text-based model representation, contextual model data, and the one or more assessment queries, into vectorized semantic representations. These embeddings allow the AI-based reasoning subsystem 218 to maintain relational awareness while generating the one or more analytical responses. In one enablement example, the system 102 may utilize transformer-based encoder layers that convert PMML-derived textual descriptions (such as transformation rules or decision logic) into contextual embeddings. These embeddings assist the AI-based reasoning subsystem 218 in grounding its output strictly on the information supplied within the aggregated prompt context, thereby reducing hallucinations and ensuring factual accuracy.

The semantic reasoning refers to the structured inferential process through which the AI-based reasoning subsystem 218 derives analytical meaning from the contextual embeddings and the rules specified within the one or more prompt orchestration directives. The semantic reasoning may include identifying causal relationships (e.g., how transformations influence predictions), detecting inconsistencies (e.g., mismatched feature scales), or synthesizing multidimensional insights (e.g., combining operational alignment issues with model governance risks). In one exemplary embodiment, the AI-based reasoning subsystem 218 may apply a layered reasoning approach where the LLM first summarizes model details, then verifies logical consistency, and finally generates evaluative commentary aligned with the plurality of assessment dimensions defined in the multidimensional assessment subsystem 212.

The natural-language generation, as used herein, refers to the process of converting the internal semantic reasoning outputs into structured, human-readable narratives, tables, or formatted analytical responses. The natural-language generation mechanism may be constrained by output-format constraints embedded earlier in the prompt, such as requiring bullet points, structured tables, or JSON-formatted responses. In one example enablement scenario, the AI-based reasoning subsystem 218 may generate an analytical response that includes a table listing feature dependencies, a narrative describing transformation irregularities, and a JSON block summarizing risks, all within a single response.

In some exemplary embodiments, the AI-based reasoning subsystem 218 may implement response guardrails during its generative-reasoning operations. The implement response guardrails may require the AI-based reasoning subsystem 218 to cite specific parsed elements (e.g., a particular MiningField or OutputField), avoid undefined assumptions, and explicitly signal lack of sufficient context by generating statements such as “INSUFFICIENT INFORMATION TO ANSWER”. The response guardrails enforcement may be implemented internally by the LLM via system instructions or externally through post-processing modules that validate generated outputs.

For instance, the one or more rule-based prompts are transmitted to the Ollama-based backend, which executes a deployed LLM instance. The LLM interprets the layered prompt—consisting of system instructions, context pack, user queries, and constraints, and generates the structured response. The AI-based reasoning subsystem 218 then extracts the generated content, validates it against guardrails, and returns the analytical responses to the downstream model optimization subsystem 220 for further processing.

In an exemplary embodiment, the model optimization subsystem 220 is configured to generate the one or more optimization recommendations for the predictive AI model based on the one or more analytical responses and the structured assessment output to optimize the predictive AI model. The one or more optimization recommendations refer to technically actionable, model-specific enhancement suggestions derived from generative reasoning results and multidimensional assessment insights. The one or more optimization recommendations may include improvements to feature engineering, adjustments to transformation logic, refinement of decision boundaries, consolidation of preprocessing steps, mitigation of model risks, or operational reconfigurations that improve the predictive AI model’s reliability, robustness, interpretability, or compliance with organizational requirements.

The model optimization subsystem 220 uses both the structured assessment output generated by the multidimensional assessment subsystem 212, and the one or more analytical responses generated by the AI-based reasoning subsystem 218 to synthesize improvement strategies. The structured assessment output provides a taxonomy of the predictive AI model’s strengths, deficiencies, model risks, and performance characteristics mapped to the plurality of assessment dimensions, including operational alignments, data quality, model engineering, model governance, decision-system integrity, environmental impact, and social impact. The one or more analytical responses provide deeper narrative insight into specific logical behaviors, dependency patterns, transformation chains, and decision rules uncovered by generative reasoning. The model optimization subsystem 220 consolidates these two information sources to determine both high-level and granular optimization pathways.

In one exemplary embodiment, the model optimization subsystem 220 may implement a rule aggregation engine that correlates deficiencies identified in the structured assessment output with corresponding optimization templates. For example, if the analytical responses indicate that a transformation chain contains redundant normalization steps, the model optimization subsystem 220 may generate an optimization recommendation to streamline the preprocessing pipeline. Similarly, if the structured assessment output identifies misalignment between the predictive AI model logic and commercial context parameters (for example, missing thresholds required for regulatory compliance), the model optimization subsystem 220 may recommend modifications to the decision logic or inclusion of additional guard conditions.

In another exemplary embodiment, the model optimization subsystem 220 may apply pattern-matching techniques to identify recurring model weaknesses, such as heavy dependence on a single feature, inconsistent score distributions across population segments, or excessive use of nonlinear transformations that complicate interpretability. Pattern-matching rules may be derived from domain heuristics, organizational guidelines, or machine-learning governance frameworks. When a recognized pattern is detected, the model optimization subsystem 220 produces the one or more optimization recommendations, such as revising feature weighting, adjusting model complexity, or incorporating additional calibration mechanisms.

The model optimization subsystem 220 may also employ parameter sensitivity analysis when generating optimization recommendations. As used herein, parameter sensitivity analysis refers to the evaluation of how changes in statistical parameters (such as logistic regression coefficients, decision-tree split thresholds, or gradient boosting learning rates) influence output behavior. While the system 102 does not retrain the predictive AI model, it analyzes the relationships identified in the text-based model representation and uses reasoning-derived insights to infer which parameters are likely contributors to deficiencies. For example, if the AI-based reasoning subsystem 218 identifies oversteer in the model’s scoring logic such as overly aggressive decision boundaries the model optimization subsystem 220 may recommend parameter tuning or threshold recalibration.

For instance, if the structured assessment output indicates that the predictive AI model exhibits sensitivity to a protected attribute (e.g., age or income) in the model governance dimension, and the analytical responses identify specific transformation or decision nodes where this dependency occurs, the model optimization subsystem 220 may recommend: (a) removal or modification of dependency-inducing rules, (b) introduction of fairness constraints, (c) incorporation of alternative proxy features, or (d) alignment with fairness-aware transformation techniques. The one or more optimization recommendations are generated without modifying the predictive AI model directly but provide actionable guidance for downstream practitioners.

In another enablement example, if the analytical responses highlight instability in output behavior due to inconsistent feature scaling across subsets of the training dataset, the model optimization subsystem 220 may recommend applying standardized scaling, uniform normalization, or regularized transformation pipelines to improve model reliability. Similarly, if the structured assessment output signals low operational alignments such as mismatch between the model’s output range and downstream consumption systems the model optimization subsystem 220 may recommend output calibration transformations or integration of post-processing rules to ensure compatibility.

In certain embodiments, the model optimization subsystem 220 may employ a recommendation ranking mechanism that prioritizes optimization suggestions based on severity, potential impact, and alignment with the plurality of assessment dimensions. For instance, model governance deficiencies (such as lack of required audit metadata) may be ranked higher than minor transformation inconsistencies. This ranking enables practitioners to focus on recommendations that meaningfully enhance the predictive AI model’s risk posture and operational reliability.

The model optimization subsystem 220 may additionally format its one or more optimization recommendations using the output-format constraints defined in the one or more prompt orchestration directives. These may include structured tables, prioritized lists, stepwise remediation plans, or machine-readable JSON summaries, enabling integration with enterprise model-governance platforms or automated continuous integration / continuous deployment (CI/CD) workflows.

By generating the one or more optimization recommendations grounded in both rule-based assessment and Gen-AI-derived analytical insight, the model optimization subsystem 220 enables a technically rigorous, contextually informed enhancement process for the predictive AI model. The model optimization subsystem 220 thereby ensures that optimization is not generic but directly tied to the predictive AI model’s intrinsic structure, operational context, and multidimensional risk profile.

In some exemplary embodiments, the system 102 includes a reasoning-failover module configured to ensure continuity of generative reasoning operations. When the Ollama-based backend becomes unavailable or returns an error, the system 102 performs automatic retries with exponential backoff, switches to an alternate LLM provider if configured, or invokes a local rule-based reasoning engine capable of producing basic deterministic responses. Errors are logged in structured format and surfaced to the user interface 120 to maintain transparency. This redundancy ensures uninterrupted assessment workflows.

In some exemplary embodiments, the system 102 includes a conversation management module. The conversation management module is configured to store interaction history in a NoSQL document database using structured JSON records. Each conversation is indexed by session identifier, timestamp, user profile identifier, and model identifier. The stored data includes the aggregated prompt context, the one or more assessment queries, the one or more analytical responses, and navigation metadata. Conversation history persists across sessions, allowing later retrieval, auditability, and reproducibility of assessments. The conversation management module may also provide export features enabling users to download histories in JSON, PDF, or text formats for documentation or governance review.

In certain exemplary embodiments, the system 102 supports chunked ingestion and streamed parsing of large model files. The ingestion subsystem 206 partitions the predictive AI model file into size-bounded segments and performs progressive validation, thereby preventing memory overload when processing multi-gigabyte models. The PMML parsing is performed using streamed Simple API for XML (SAX)-based parsing to reduce memory footprint, while serialized machine-learning model file formats utilize lazy-loading techniques. When the predictive AI model exceeds predefined size thresholds, the system 102 prompts the user with optimization instructions such as compressing the model, exporting only necessary estimators, or converting to ONNX for efficient analysis.

In an exemplary embodiment, the system 102 is configured to implement multiple layers of security protections to safeguard proprietary model artifacts, contextual model data, and user-provided information. The system 102 may utilize strong encryption mechanisms, such as Advanced Encryption Standard (AES-256) encryption, to secure all files and data stored at rest within the storage unit 204 or associated repositories. For in-transit protection, the system 102 may employ Transport Layer Security (TLS) to ensure that communications between the user interface 120, the one or more server platforms, and external service endpoints remain cryptographically protected against interception and tampering. Prior to transmitting any prompt content to external application programming interfaces (APIs), the system 102 may perform prompt-sanitization procedures configured to remove, mask, hash, or otherwise obfuscate sensitive information, thereby preventing exposure of proprietary or regulated data. In certain embodiments, the system 102 further employs access-controlled storage mechanisms to ensure that only authorized entities are permitted to retrieve or modify protected artifacts. These combined security controls strengthen the confidentiality, integrity, and availability of model files and operational data throughout the processing lifecycle.

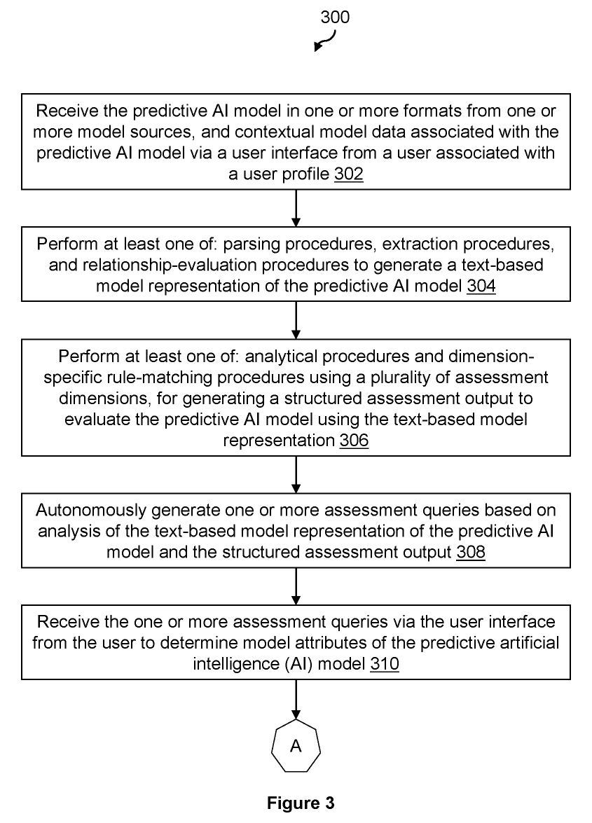

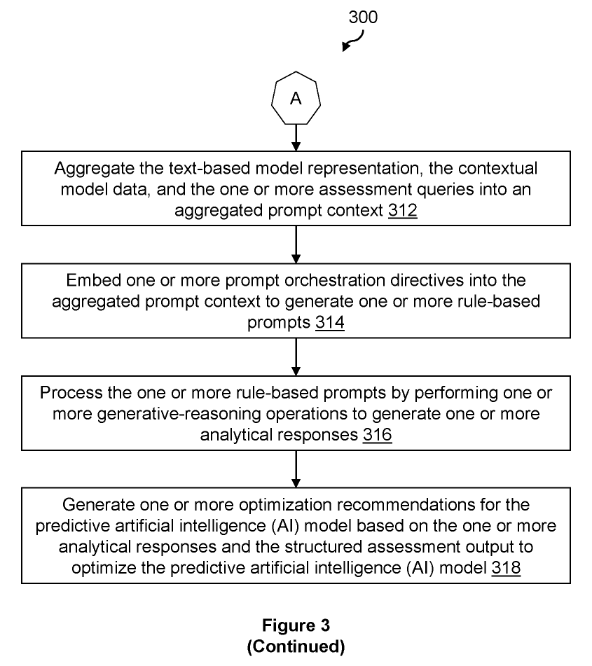

FIG. 3 illustrates an exemplary flowchart of the Gen-AI-based method 300 for optimizing the predictive AI model through the multidimensional assessment, in accordance with an embodiment of the present disclosure.

In accordance with another embodiment of the present disclosure, the Gen-AI-based method 300 for optimizing the predictive AI model through multidimensional assessment is disclosed. At step 302, the Gen-AI-based method 300 includes receiving, by the one or more hardware processors 110 through the ingestion subsystem 206, the predictive AI model in the one or more formats from the one or more model sources 118, and the contextual model data associated with the predictive AI model via the user interface from the user associated with the user profile. The predictive AI model in the one or more formats comprises one of: the PMML file format, the XML file format containing the PMML content, and the serialized machine-learning model file format. The contextual model data comprises at least one of: the model metadata, the model version information, the feature descriptions, the training dataset characteristics, the commercial context parameters, the performance metrics, the model governance attributes, the deployment environment information, the usage constraints, and the intended application details.

In the next step, the Gen-AI-based method 300 includes converting, by the one or more hardware processors 110 through the model conversion subsystem 208, the one of: the XML file format containing the PMML content, and the serialized machine-learning model file format, into the PMML file format. At step 304, the Gen-AI-based method 300 includes performing, by the one or more hardware processors 110 through the model interpretation subsystem 210, at least one of: the parsing procedures, the extraction procedures, and the relationship-evaluation procedures to generate the text-based model representation of the predictive AI model.

At step 306, the Gen-AI-based method 300 includes performing, by the one or more hardware processors 110 through the multidimensional assessment subsystem 212, at least one of: the analytical procedures and the dimension-specific rule-matching procedures using the plurality of assessment dimensions, for generating the structured assessment output to evaluate the predictive AI model using the text-based model representation.

At step 308, the Gen-AI-based method 300 includes autonomously generating, by the one or more hardware processors 110 through the Gen-AI subsystem 214, the one or more assessment queries based on analysis of the text-based model representation of the predictive AI model and the structured assessment output. At step 310, the Gen-AI-based method 300 includes receiving, by the one or more hardware processors 110 through the Gen-AI subsystem 214, the one or more assessment queries via the user interface from the user to determine model attributes of the predictive AI model. The model attributes comprise at least one of: the detailed characteristics of the predictive AI model, the dependencies of the predictive AI model, the decision logic, the model risks, and the model behaviors.

At step 312, the Gen-AI-based method 300 includes aggregating, by the one or more hardware processors 110 through the prompt management subsystem 216, the text-based model representation, the contextual model data, and the one or more assessment queries into the aggregated prompt context. At step 314, the Gen-AI-based method 300 includes embedding, by the one or more hardware processors 110 through the prompt management subsystem 216, the one or more prompt orchestration directives into the aggregated prompt context to generate the one or more rule-based prompts. The one or more prompt orchestration directives comprise at least one of: the Gen-AI-based system instructions, the output-format constraints, the analysis directives, and the response guardrails.

At step 316, the Gen-AI-based method 300 includes processing, by the one or more hardware processors 110 through the AI-based reasoning subsystem 218, the one or more rule-based prompts by performing the one or more generative-reasoning operations to generate the one or more analytical responses. The one or more generative-reasoning operations comprise at least one of: the prompt interpretation, the contextual embedding, the semantic reasoning, and the natural-language generation.

At step 318, the Gen-AI-based method 300 includes generating, by the one or more hardware processors 110 through the model optimization subsystem 220, the one or more optimization recommendations for the predictive AI model based on the one or more analytical responses and the structured assessment output to optimize the predictive AI model.

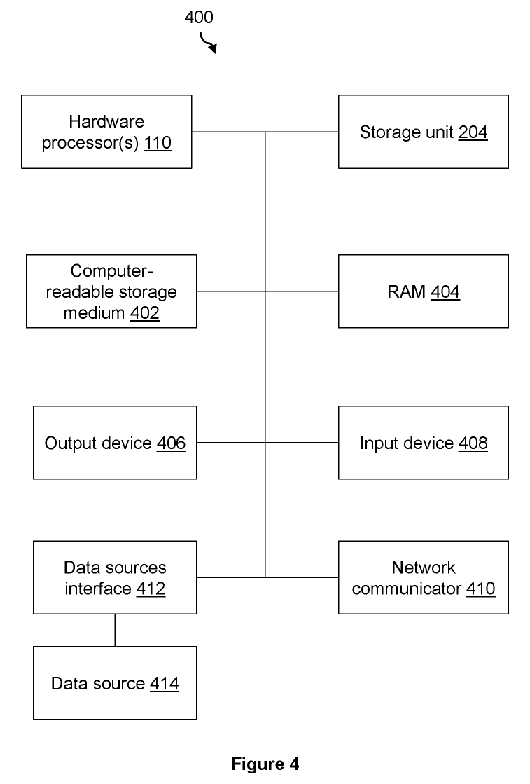

FIG. 4 illustrates an exemplary block diagram representation of one or more server platforms 400 for optimizing the predictive AI model through the multidimensional assessment, in accordance with an embodiment of the present disclosure.

In an exemplary embodiment, and for purposes of brevity, the construction and operational features of the system 102 previously described are not repeated in detail herein. The functionalities of the system 102 may be executed on a wide variety of computing machines, including but not limited to internal or external server clusters, desktops, laptops, smartphones, tablets, edge devices, cloud-based computing nodes, or any combination thereof. As illustrated in FIG. 4, the one or more server platforms 400 may include additional components not shown and, in certain embodiments, one or more of the components depicted may be omitted, combined, or substituted as required for deployment. For example, a computer system equipped with the GPUs, the TPUs, or other hardware accelerators may reside on internal printed circuit boards (PCBs) or may be provisioned on external cloud environments such as Amazon^{®} Web Services (AWS), Google^{®} Cloud Platform (GCP), Microsoft^{®} Azure, internal corporate cloud infrastructures, or organizational high-performance computing resources. Such configurable computing environments may be utilized to support the execution of the plurality of subsystems 114, including the ingestion subsystem 206, the model conversion subsystem 208, the model interpretation subsystem 210, the multidimensional assessment subsystem 212, the Gen-AI subsystem 214, the prompt management subsystem 216, the AI-based reasoning subsystem 218, and the model optimization subsystem 220.

The one or more server platforms 400 may represent a computer system, such as the system 102, that may be used to implement the embodiments described herein. The computer system may include a computational platform incorporating components that may reside on the one or more servers 108 or on any other suitable computing infrastructure. The computer system may utilize the one or more hardware processors 110 (e.g., single or multiple processors) or other hardware processing circuits to execute the methods, functions, and operations described herein. These methods and operations may be embodied as machine-readable instructions stored on a non-transitory computer-readable storage medium, such as the RAM, the ROM, the EPROM, the EEPROM, the flash memory, the solid-state drives, the hard disk drives, or other suitable storage technologies. The computer system may include the one or more hardware processors 110 that execute software instructions or code stored on the non-transitory computer-readable storage medium 402 to perform operations of the present disclosure.

In certain embodiments, the machine-readable instructions implement the plurality of subsystems 114, including the ingestion subsystem 206, the model conversion subsystem 208, the model interpretation subsystem 210, the multidimensional assessment subsystem 212, the Gen-AI subsystem 214, the prompt management subsystem 216, the AI-based reasoning subsystem 218, and the model optimization subsystem 220. The one or more server platforms 400 collectively host, execute, and manage the operations necessary to ingest the predictive AI models, generate the text-based model representation, perform the multidimensional assessments, formulate and manage the one or more assessment queries, construct the rule-based prompts, execute the generative-reasoning operations, and generate the one or more optimization recommendations for the predictive AI model.

The instructions stored on the computer-readable storage medium 402 may be retrieved and loaded into the storage unit 204 or the RAM 404 for execution. The storage unit 204 may retain static or persistent data, including machine-readable instructions and configuration parameters associated with the plurality of subsystems 114. In certain embodiments, the retrieved instructions may be compiled, interpreted, or otherwise transformed into executable forms and temporarily stored in the RAM 404 to enable high-speed access during runtime. The one or more hardware processors 110 may read the instructions stored in the RAM 404 and execute them to perform the operations of the system 102, including ingesting predictive AI models, generating the text-based model representations, executing the multidimensional assessment operations, managing the prompt construction, performing AI-based generative reasoning, and generating the one or more optimization recommendations for the predictive AI model.

The computer system may further include an output device 406 configured to present at least some of the results generated during execution of the plurality of subsystems 114, including, but not limited to, visual representations of the text- based model representation, structured assessment outputs, analytical responses generated by the AI-based reasoning subsystem, and the one or more optimization recommendations associated with the predictive AI model. The output device 406 may include a display integrated into the one or more end devices 106, such as a laptop screen, desktop monitor, tablet display, or mobile device screen, and may present graphical user interfaces (GUIs), dashboards, textual summaries, or other visual elements that enable the user to interact with and interpret system-generated outputs.

The computer system may further include an input device 408 through which one or more users or external systems may provide input data or otherwise interact with the system 102. The input device 408 may include, for example, a keyboard, keypad, mouse, touchscreen, stylus, or other suitable input peripherals. The users may employ the input device 408 to upload predictive AI models, provide/enter the contextual model data, submit assessment queries, or control system operations via the user interface 120. Each of the output device 406 and the input device 408 may be supplemented with additional peripherals as required for specific deployment environments.

A network communicator 410 may be provided to connect the computer system to a network and, in turn, to other devices connected to the network, including external systems, servers, data stores, and the user interfaces. The network communicator 410 may include, for example, a network adapter such as a LAN adapter, a wireless adapter, or any other communication interface capable of supporting data transmission using wired or wireless communication protocols. The computer system may further include a data sources interface 412 configured to access a data source 414.

In an exemplary embodiment, the data source 414 may represent an internal or external repository storing at least one of: predictive AI model files, the contextual model data, the text-based model representations, the structured assessment outputs, the assessment dimension definitions, analytical rule sets, generative query templates, the one or more prompt orchestration directives, historical analytical responses, and the one or more optimization recommendations generated by the system 102. As an example, the one or more databases 104 may serve as the data source 414.

The data sources interface 412 may enable structured querying, retrieval, and update operations on the data source 414 using standard communication mechanisms and protocols such as Structured Query Language (SQL), Representational State Transfer (REST), or Graph Query Language (GraphQL). In certain embodiments, the data source 414 may include, but is not limited to, the one or more databases 104, cloud-based storage repositories (for example, Amazon^{®} S3, Azure^{®} Blob Storage, or Google^{®} Cloud Storage), or local enterprise data warehouses that maintain versioned records of the predictive AI models, generated assessment artifacts, and optimization recommendations utilized or produced by the system 102.

Numerous advantages of the present disclosure may be apparent from the discussion above. In accordance with the present disclosure, the Gen-AI-based method for optimizing the predictive AI model through the multidimensional assessment is disclosed. The present disclosure provides significant technical advancements over existing model-assessment and explainability techniques by enabling automated, end-to-end transformation of heterogeneous predictive AI model formats into a standardized PMML-based representation, followed by generation of a comprehensive text-based model representation without requiring direct model execution.

Unlike conventional tools that rely on isolated explainability models or manual documentation, the disclosed system integrates structured rule-driven assessment with generative AI–based reasoning to produce deep, context-aware analytical insights. The system further introduces a unified prompt-orchestration framework that embeds guardrails, system instructions, and analysis directives to ensure deterministic, fully grounded reasoning by the AI-based reasoning subsystem, thereby reducing hallucination risk and increasing analytical reliability. Additionally, the disclosed approach provides a novel multidimensional assessment mechanism covering operational alignment, data quality, model engineering, governance, decision-system integrity, environmental impact, and social impact, to deliver a holistic and interpretable risk-and-performance profile for any predictive AI model. The combination of automated normalization, semantic interpretation, Gen-AI-driven query generation, structured prompt orchestration, grounded analytical reasoning, and model-specific optimization recommendations represents a substantial technical improvement over prior manual, fragmented, or model-type-specific evaluation workflows. The disclosed system therefore enhances model transparency, reduces assessment effort, improves auditability, and accelerates safe operational deployment of predictive AI models in enterprise environments.

The system ensures clear, comprehensive project documentation. The system shares learnings across user teams. The system establishes guidelines for efficient development. The system captures insights from previous successes and failures. The system identifies decision-making responsibilities across the one or more artificial intelligence models and the user teams. The system maps out roles for the predictive AI models and the users. The system specifies protocols for escalating critical cases. For instance, in credit scoring, the predictive AI models automate decisions for optimal scores, with user review for borderline cases. The system aligns the predictions with actionable outcomes. The system sets thresholds for high risk (>80 percent probability), medium risk (50 percent to 80 percent probability), and low risk (<50 percent probability). The system defines actions for each risk level. The system allows the one or more users to intervene and override decisions. The system incorporates feedback to improve decision-making processes. The system ensures decisions are transparent, compliant, and well-documented. The system keeps records of all decisions and rationales. The system logs all decision-making steps for review. The system tracks adherence to regulatory guidelines.

The system analyzes the consequences of decisions and the alignment with the business goals. The system evaluates the effects of decisions on the one or more users. The system balances decision costs against expected benefits. For instance, insurance risk models assess the accuracy of claim predictions. The system prepares for unexpected failures with recovery mechanisms. The system defines fallback actions for common failures. The system details steps for restoring operations after issues. The system ensures uninterrupted services during crises. For instance, automated customer service systems switch to user agents during failures.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words "comprising," "having," "containing," and "including," and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A generative artificial intelligence (Gen-AI)-based method for optimizing a predictive artificial intelligence (AI) model through multidimensional assessment, the generative artificial intelligence (Gen-AI)-based method comprising:
receiving, by one or more hardware processors through an ingestion subsystem, the predictive artificial intelligence (AI) model in one or more formats from one or more model sources, and contextual model data associated with the predictive artificial intelligence (AI) model via a user interface from a user associated with a user profile;
performing, by the one or more hardware processors through a model interpretation subsystem, at least one of: parsing procedures, extraction procedures, and relationship-evaluation procedures to generate a text-based model representation of the predictive artificial intelligence (AI) model;
performing, by the one or more hardware processors through a multidimensional assessment subsystem, at least one of: analytical procedures and dimension-specific rule-matching procedures using a plurality of assessment dimensions, for generating a structured assessment output to evaluate the predictive artificial intelligence (AI) model using the text-based model representation;
autonomously generating, by the one or more hardware processors through a generative artificial intelligence (Gen-AI) subsystem, one or more assessment queries based on analysis of the text-based model representation of the predictive artificial intelligence (AI) model and the structured assessment output;
receiving, by the one or more hardware processors through the generative artificial intelligence (Gen-AI) subsystem, the one or more assessment queries via the user interface from the user to determine model attributes of the predictive artificial intelligence (AI) model;
aggregating, by the one or more hardware processors through a prompt management subsystem, the text-based model representation, the contextual model data, and the one or more assessment queries into an aggregated prompt context;
embedding, by the one or more hardware processors through the prompt management subsystem, one or more prompt orchestration directives into the aggregated prompt context to generate one or more rule-based prompts;
processing, by the one or more hardware processors through an artificial intelligence (AI)-based reasoning subsystem, the one or more rule-based prompts by performing one or more generative-reasoning operations to generate one or more analytical responses; and
generating, by the one or more hardware processors through a model optimization subsystem, one or more optimization recommendations for the predictive artificial intelligence (AI) model based on the one or more analytical responses and the structured assessment output to optimize the predictive artificial intelligence (AI) model.

2. The generative artificial intelligence (Gen-AI)-based method of claim 1, wherein the predictive artificial intelligence (AI) model in the one or more formats comprises one of: a predictive model markup language (PMML) file format, an extensible markup language (XML) file format containing a predictive model markup language (PMML) content, and a serialized machine-learning model file format.

3. The generative artificial intelligence (Gen-AI)-based method of claim 1, wherein the contextual model data comprises at least one of: model metadata, model version information, feature descriptions, training dataset characteristics, commercial context parameters, performance metrics, model governance attributes, deployment environment information, usage constraints, and intended application details.

4. The generative artificial intelligence (Gen-AI)-based method of claim 1, further comprising:
converting, by the one or more hardware processors through a model conversion subsystem, the one of: the extensible markup language (XML) file format containing the predictive model markup language (PMML) content, and the serialized machine-learning model file format, into the predictive model markup language (PMML) file format.

5. The generative artificial intelligence (Gen-AI)-based method of claim 1, wherein
the parsing procedures comprise processing the predictive model markup language (PMML) file format associated with the predictive artificial intelligence (AI) model together with the contextual model data to identify parsed model elements comprising at least one of: a model type, input fields, transformation logic, decision logic, and output specifications;
the extraction procedures comprise retrieving predictive artificial intelligence (AI) model components comprising at least one of: feature definitions, statistical parameters, threshold conditions, preprocessing steps, and scoring rules from the parsed model elements; and
the relationship-evaluation procedures comprise analyzing relationships among the parsed model elements and the extracted predictive artificial intelligence (AI) model components to identify at least one of: feature-to-prediction dependencies, transformation chains, and scoring flows.

6. The generative artificial intelligence (Gen-AI)-based method of claim 1, wherein the analytical procedures comprise at least one of: identifying feature coverage, transformation consistency, model logic structure, sensitive-attribute usage, complexity indicators, and output behavior.

7. The generative artificial intelligence (Gen-AI)-based method of claim 1, wherein the plurality of assessment dimensions comprise at least one of: operational alignments, a data quality, model engineering, model governance, decision-system integrity, an environmental impact, and a social impact.

8. The generative artificial intelligence (Gen-AI)-based method of claim 1, wherein the structured assessment output comprises at least one of: identified strengths, deficiencies, model risks, and performance characteristics of the predictive artificial intelligence (AI) model mapped to the plurality of assessment dimensions.

9. The generative artificial intelligence (Gen-AI)-based method of claim 1, wherein the model attributes comprise at least one of: detailed characteristics of the predictive artificial intelligence (AI) model, dependencies of the predictive artificial intelligence (AI) model, the decision logic, the model risks, and model behaviors.

10. The generative artificial intelligence (Gen-AI)-based method of claim 1, wherein the one or more prompt orchestration directives comprise at least one of: generative artificial intelligence (Gen-AI)-based system instructions, output-format constraints, analysis directives, and response guardrails.

11. The generative artificial intelligence (Gen-AI)-based method of claim 1, wherein the one or more generative-reasoning operations comprise at least one of: prompt interpretation, contextual embedding, semantic reasoning, and natural-language generation.

12. A generative artificial intelligence (Gen-AI)-based system for optimizing a predictive artificial intelligence (AI) model through multidimensional assessment, the generative artificial intelligence (Gen-AI)-based system comprising:
one or more hardware processors;
a memory unit operatively connected to the one or more hardware processors, wherein the memory unit comprises a set of instructions in form of a plurality of subsystems, configured to be executed by the one or more hardware processors, wherein the plurality of subsystems comprises:
an ingestion subsystem configured to receive the predictive artificial intelligence (AI) model in one or more formats from one or more model sources, and to receive contextual model data associated with the predictive artificial intelligence (AI) model via a user interface from a user associated with a user profile;
a model interpretation subsystem configured to generate a text-based model representation of the predictive artificial intelligence (AI) model by performing at least one of: parsing procedures, extraction procedures, and relationship-evaluation procedures;
a multidimensional assessment subsystem configured to evaluate the predictive artificial intelligence (AI) model using the text-based model representation by performing at least one of: analytical procedures and dimension-specific rule-matching procedures using a plurality of assessment dimensions, for generating a structured assessment output;
a generative artificial intelligence (Gen-AI) subsystem configured to at least one of:
autonomously generate one or more assessment queries based on analysis of the text-based model representation of the predictive artificial intelligence (AI) model and the structured assessment output; and
receive the one or more assessment queries via the user interface from the user for determining model attributes of the predictive artificial intelligence (AI) model;
a prompt management subsystem configured to:
aggregate the text-based model representation, the contextual model data, and the one or more assessment queries into an aggregated prompt context; and
embed one or more prompt orchestration directives into the aggregated prompt context to generate one or more rule-based prompts;
an artificial intelligence (AI)-based reasoning subsystem configured to process the one or more rule-based prompts by performing one or more generative-reasoning operations to generate one or more analytical responses;
a model optimization subsystem configured to generate one or more optimization recommendations for the predictive artificial intelligence (AI) model based on the one or more analytical responses and the structured assessment output to optimize the predictive artificial intelligence (AI) model.

13. The generative artificial intelligence (Gen-AI)-based system of claim 12, wherein the ingestion subsystem configured to receive:
the predictive artificial intelligence (AI) model in the one or more formats comprises one of: a predictive model markup language (PMML) file format, an extensible markup language (XML) file format containing a predictive model markup language (PMML) content, a serialized machine-learning model file format; and
the contextual model data comprises at least one of: model metadata, model version information, feature descriptions, training dataset characteristics, commercial context parameters, performance metrics, model governance attributes, deployment environment information, usage constraints, and intended application details.

14. The generative artificial intelligence (Gen-AI)-based system of claim 12, wherein the plurality of subsystems further comprises:
a model conversion subsystem configured to convert the one of: the extensible markup language (XML) file format containing the predictive model markup language (PMML) content, and the serialized machine-learning model file format, into the predictive model markup language (PMML) file format.

15. The generative artificial intelligence (Gen-AI)-based system of claim 12, wherein
the parsing procedures comprise processing the predictive model markup language (PMML) file format associated with the predictive artificial intelligence (AI) model together with the contextual model data to identify parsed model elements comprising at least one of: a model type, input fields, a transformation logic, a decision logic, and output specifications;
the extraction procedures comprise retrieving predictive artificial intelligence (AI) model components comprising at least one of: feature definitions, statistical parameters, threshold conditions, preprocessing steps, and scoring rules from the parsed model elements; and
the relationship-evaluation procedures comprise analyzing relationships among the parsed model elements and the extracted predictive artificial intelligence (AI) model components to identify at least one of: feature-to-prediction dependencies, transformation chains, and scoring flows.

16. The generative artificial intelligence (Gen-AI)-based system of claim 12, wherein the multidimensional assessment subsystem performing at least one of:
the analytical procedures comprise at least one of: identifying feature coverage, transformation consistency, model logic structure, sensitive-attribute usage, complexity indicators, and output behavior;
the dimension-specific rule-matching procedures using the plurality of assessment dimensions comprise at least one of: operational alignments, a data quality, model engineering, model governance, decision-system integrity, an environmental impact, and a social impact, for generating the structured assessment output,
the structured assessment output comprises at least one of: identified strengths, deficiencies, model risks, and performance characteristics of the predictive artificial intelligence (AI) model mapped to the plurality of assessment dimensions.

17. The generative artificial intelligence (Gen-AI)-based system of claim 12, wherein the model attributes comprise at least one of: detailed characteristics of the predictive artificial intelligence (AI) model, dependencies of the predictive artificial intelligence (AI) model, the decision logic, the model risks, and model behaviors.

18. The generative artificial intelligence (Gen-AI)-based system of claim 12, wherein the one or more prompt orchestration directives comprise at least one of: generative artificial intelligence (Gen-AI)-based system instructions, output-format constraints, analysis directives, and response guardrails.

19. The generative artificial intelligence (Gen-AI)-based system of claim 12, wherein the one or more generative-reasoning operations comprise at least one of: prompt interpretation, contextual embedding, semantic reasoning, and natural-language generation.

20. A non-transitory computer-readable storage medium storing a set of instructions that, when executed by one or more hardware processors, cause the one or more hardware processors to perform operations for optimizing a predictive artificial intelligence (AI) model through multidimensional assessment, the operations comprising:
receiving the predictive artificial intelligence (AI) model in one or more formats from one or more model sources, and contextual model data associated with the predictive artificial intelligence (AI) model via a user interface from a user associated with a user profile;
performing at least one of: parsing procedures, extraction procedures, and relationship-evaluation procedures to generate a text-based model representation of the predictive artificial intelligence (AI) model;
performing at least one of: analytical procedures and dimension-specific rule-matching procedures using a plurality of assessment dimensions, for generating a structured assessment output to evaluate the predictive artificial intelligence (AI) model using the text-based model representation;
autonomously generating one or more assessment queries based on analysis of the text-based model representation of the predictive artificial intelligence (AI) model and the structured assessment output;
receiving the one or more assessment queries via the user interface from the user to determine model attributes of the predictive artificial intelligence (AI) model;
aggregating the text-based model representation, the contextual model data, and the one or more assessment queries into an aggregated prompt context;
embedding one or more prompt orchestration directives into the aggregated prompt context to generate one or more rule-based prompts;
processing the one or more rule-based prompts by performing one or more generative-reasoning operations to generate one or more analytical responses; and
generating one or more optimization recommendations for the predictive artificial intelligence (AI) model based on the one or more analytical responses and the structured assessment output to optimize the predictive artificial intelligence (AI) model.
